(19) United States
(12) Patent Application Publication
(10) Pub. No.: US 2004/0222559 A1
(43) Pub. Date: Nov. 11, 2004

(54) In mold closing mechanism

(76) Inventors: Manuel J. Gomes, Flamborough (CA); Allan Hall, Toronto (CA); Bounoth Meksavanh, Mississauga (CA); Harald Gaul, Shanty Bay (CA)

Correspondence Address: Elias C. Borges, Suite 406, 1 Eva Road, Toronto, M9C 4Z5, CA

(21) Appl. No.: 10/430,206

(22) Filed: May 7, 2003

(51) Int. Cl. B29C 53/02; B29C 69/02

(52) U.S. Cl. 264/296; 425/324.1; 425/394

(57) ABSTRACT

The present invention is a mechanism for folding plastic injection molded parts after the parts have been molded and while the parts are still on the mold core half. The mechanism consists of a mold core half having one or more mold cores. The mold core half has a finger movably mounted adjacent the mold core half and movable along a predetermined path between a first position wherein the finger is clear of the mold core and a second position wherein the finger bears against the part on the mold core so as to fold the part. The invention also includes a drive (either electrical, hydraulic or pneumatic) for driving the finger between its first and second positions. The present invention also consists of a method of in-mold folding of a foldable plastic part. The method consists of projecting a finger across a face of the mold core half and towards the plastic part sitting on the mold core such that the finger engages a lower edge of a first portion of the plastic part. The finger is then forced upwardly away from the mold core and towards a second portion of the plastic part in order to fold the first portion onto the second portion. After folding the plastic part, the finger is moved clear of the mold core so that the part can be fully ejected from the mold core and so that the injection mold can proceed with the next molding cycle.

### FIELD OF THE INVENTION

The invention relates generally to devices for the in-mold manipulation of plastic injection molded parts.

### BACKGROUND OF THE INVENTION

The majority of closures and caps for bottles or jars in the packaging industry are single piece injection molded flip-top closures or flip-top caps. Closures or caps with a flip-top feature are a popular type in the market because of easy closure or cap handling. The flip-top closures and caps consist of two sections: a threaded or non-threaded capsule section to provide a seal for the neck of the bottle or jar, and an attached lid section that is flipped open when dispensing viscous or dry matter. The lid section is movable between a closed position wherein the lid is fully folded and an open position wherein the lid is unfolded. One piece flip-top closures and caps are also popular among custom molders because of reduction in molding equipment costs when manufacturing parts. One mold may be used to mold one piece flip-top closures or flip-top caps as opposed to two molds. Many other molded articles with flip-top feature exist in the market, as it is a convenience to the end user for its easy handling, and again a cost reduction, to the molder as a reduction in the equipment used to mold single piece as opposed to mold many pieces and running a mold for each article.

Flip-top closures and flip-top caps are produced by injection molding. Typical equipment used in the injection molding process is an injection molding machine and a mold along with additional auxiliary equipment. After each molding cycle, parts are ejected from the mold by ejection mechanism designed into the mold. The parts then fall off the mold into a bin or conveyor and then are transported to another work cell, wherein the lids are folded into their closed position either by automated closing equipment or manually by an operator. The conventional automated closing equipment is designed to capture molded part, orient it into the right position, fold its lid into closed position, and then release it. Less used and more time consuming method of folding molded part is to manually snap the lid, an operation done by an operator. The folding of the flip-top closure and flip- top caps is preferably done right after the part is ejected from the mold when the part is still hot to allow for the lid to fold into its closed position. These two ways of folding close the molded closures represent a significant complication in the manufacturing process and thus a significant increase in production costs.

An ideal device that closes lids of flip-top closures, caps or articles inside the mold would significantly decrease the production costs associated with additional equipment costs, manual labor, additional maintenance costs and additional production space. Such in-mold lid closing mechanism would also decrease production rates by eliminating wasted time between additional operations.

### SUMMARY OF THE INVENTION

The present invention overcomes the disadvantage of requiring additional equipment and labor for closing folding plastic articles by providing a mechanism for the in-mold folding of these articles. The flip-top lids are closed inside the mold within the following sequence of operations. Firstly plastic is injected into the mold to fill the mold cavities. The mold stays closed after the plastic is injected to cool the parts. The mold opens and the in-mold mechanism closes the parts while the parts still reside on the cores of the core half of the mold. Lastly, the parts are ejected from the mold by means of a built in ejection system (such as ejection pins or air).

The present invention consists of a mold core half having one or more mold cores. The mold core half has a finger movably mounted adjacent the mold core half and movable along a predetermined path between a first position wherein the finger is clear of the mold core and a second position wherein the finger bears against the part on the mold core so as to fold the part. The invention also includes a drive (either electrical, hydraulic or pneumatic) for driving the finger between its first and second positions.

The present invention also consists of a method of in-mold folding of a foldable plastic part molded on a mold core in a mold core half of a plastic injection mold. The plastic part may be any injection molded plastic part which has a first portion, such as a lid, which is intended to be folded onto a second portion such as a neck or stem. The method consists of projecting a finger across a face of the mold core half and towards the plastic part sitting on the mold core such that the finger engages a lower edge of the first portion of the plastic part. The finger is then forced upwardly away from the mold core and towards the second portion of the plastic part in order to fold the first portion onto the second portion. After folding the plastic part, the finger is moved clear of the mold core so that the part can be fully ejected from the mold core and so that the injection mold can proceed with the next molding cycle. The method may also include the step of first partially ejecting the plastic part after the part has been molded such that the part sits freely on top of the mold core.

### BRIEF DESCRIPTION OF THE DRAWINGS

FIG. 1 is a top view of an in-mold lid closing mechanism made in accordance with the present invention mounted on the core half side of an injection mold.

FIG. 2 is an isometric view of the lid closing mechanism shown in FIG. 1.

FIG. 3 is a top view of the in-mold lid closing mechanism from FIG. 1 without the injection mold.

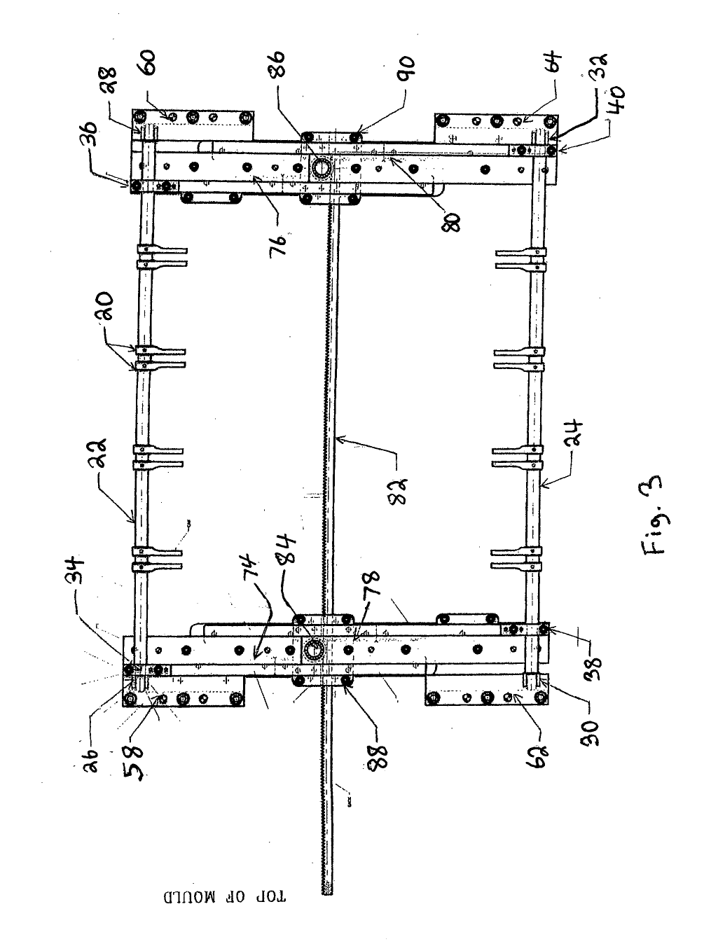

FIGS. 4a to 4h are side sectional views showing the finger portions of the lid closing mechanism mounted on the core half side of the injection mold and showing the finger portion moving sequentially from a fully retracted position as seen in FIG. 4a to a fully extended position as seen in FIG. 4h.

### DETAILED DESCRIPTION OF THE INVENTION

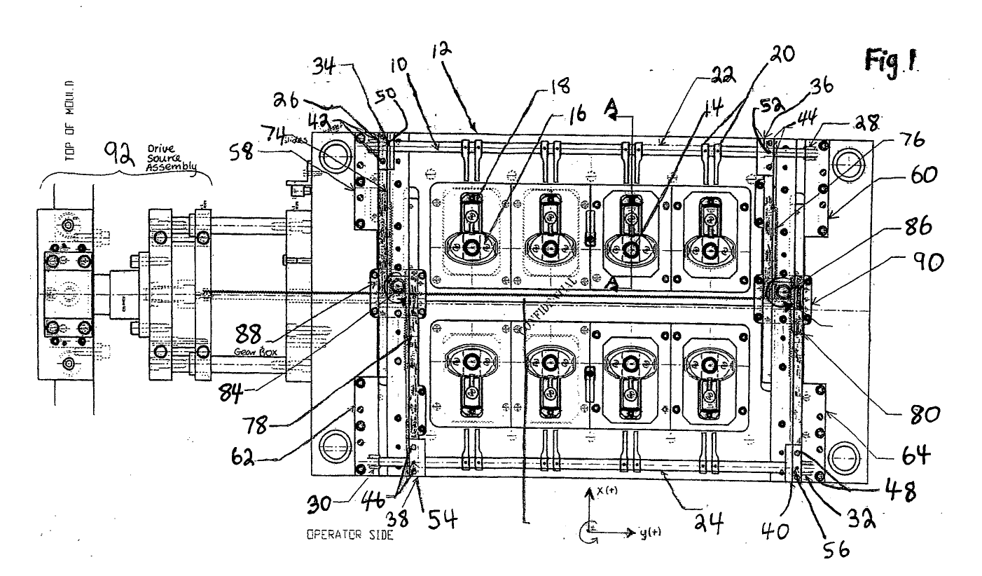

Referring firstly to FIG. 1, the present invention, shown generally as item 10, is an in-mold mechanism for folding molded plastic parts. Such parts include flip-top closures, flip-top caps or any other plastic part which is intended to be folded after being molded. The in-mold folding mechanism is mounted to mold core half 12 of the injection mold which molds the plastic parts. Mold core half 12 generally has a set of mold cores arranged in one or more rows or columns; however, the mold may have as few as one mold core. Cores 14 mold identical plastic parts. Each core has a neck/capsule portion 16 and a lid portion 18. The neck/capsule portion of the core molds the neck (or capsule) portion of the plastic part (either threaded or non-threaded). The lid portion 18 of the core molds the lid portion of the plastic part. After the parts are molded and the mold opens, the parts will reside on cores 14 until ejected.

On the top of the mechanism 10 along the y-axis is mounted a driving source assembly (driver) 92. The driving source assembly 92 can be either electric, pneumatic or hydraulic. Linked to the drive is a rack and pinion gear assembly. The rack and pinion gear assembly includes a main rack 82, which moves along the y-axis, pinion gears 84 and 86 which rotate around the z-axis, and set of rack slides 74, 78, 76, 80 which slide along the x-axis. The meshed part of the main rack 82 and pinion gears 84 and 86 are contained in gearboxes 88 and 90, respectively. Attached respectively to rack slides 74, 76, 78, and 80 by means of shaft-mounting blocks 34, 36, 38, and 40 are shafts 22 and 24. Shafts 22 and 24 are identical elongated bars. Rollers 26 and 28 are attached to opposite ends of shaft 22 and are dimensioned to engage into cams 58 and 60, respectively. Once shaft 22 is activated, rollers 26 and 28 slide along the custom designed cam paths 66 and 68, respectively. Likewise, rollers 30 and 32 are attached to opposite ends of shaft 24 and are dimensioned to engage into cams 62 and 64, respectively. Once shaft 24 is activated, rollers 30 and 32 slide along the custom designed cam paths 70 and 72, respectively. Custom designed cams 58, 60, 62 and 64 are mounted to mold core half 12. Shaft 22 is mounted to shaft mounting blocks 34 and 36 and shaft 24 is mounted to shaft mounting blocks 38 and 40. Shaft mounting blocks 34, 36, 38 and 40 are attached by means of stripper bolts 42, 44, 46 and 48 to rack slides 74, 76, 78 and 80, respectively. The stripper bolts allow movement of the shaft-mounting blocks and shafts in the z-direction. The shaft-mounting blocks 34, 36, 38 and 40 also prevent both shafts from rotating by means of setscrews 50, 52, 54 and 56. Lastly, the last component on the closing mechanism that physically closes the plastic parts are fingertips 20. Fingertips 20 are attached to shafts 22 and 24 and are oriented towards mold cores 14. Fingertips 20 are designed to reach the pivot point of the plastic part to fold the plastic part by following the shaft movement along a predetermined path. The number of fingertips varies depending on the number of parts to be molded per one mold.

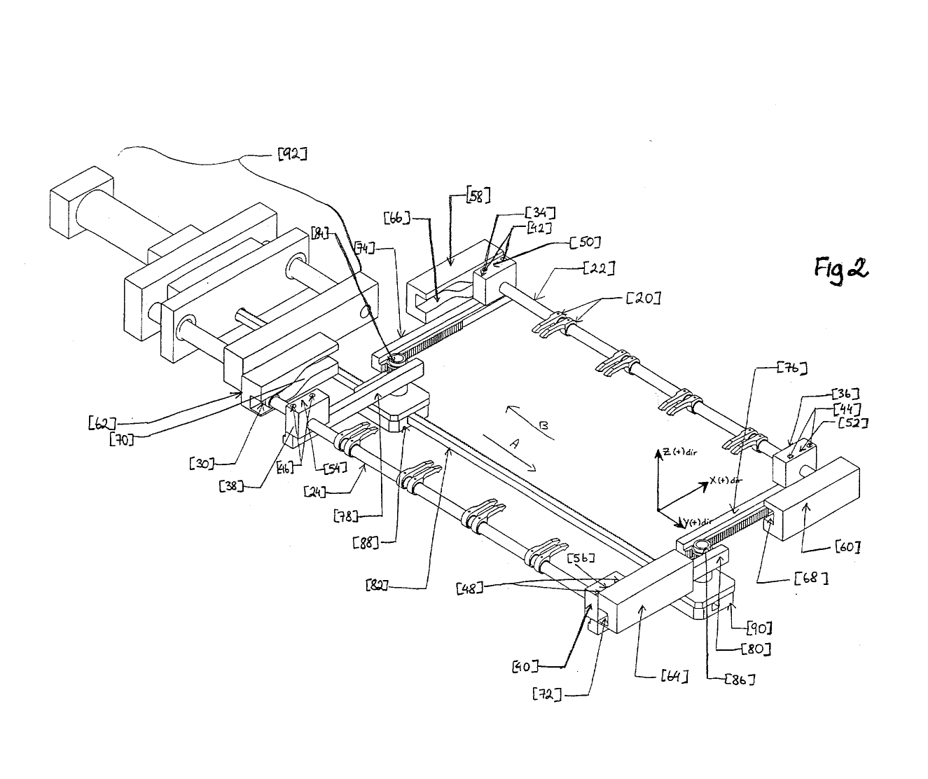

Referring now to FIG. 2, the drive source assembly 92 is coupled to main rack 82. While a hydraulic drive source assembly is depicted in the figure, the drive source assembly may comprise any suitable electric or pneumatic drive mechanism. During the molding cycle, once the mold opens (along the z-direction) and before ejecting the parts from the mold cores (not shown) drive source assembly 92 is activated. Once activated, the hydraulic cylinder exerts force on main rack 82 along the y-axis and in a positive direction (i.e. in the direction indicated by arrow A), which in turn causes the rack and pinion assembly to move fingers 20 towards each other in order to fold close the plastic parts (not shown). The main rack 82 converts its linear motion into counter clockwise rotational motion (about the z-axis) of pinion gears 84 and 86. The rotational motion from the pinion gear 84 and 86 is then converted into linear motion of the rack slides 74, 78, 76 and 80. Rack slides 78 and 80 move along the x-axis in a positive direction while rack slides 74 and 76 move along the x-axis in a negative direction (i.e. opposite the direction of the movement of rack slides 78 and 80). This sequence of movements activates the rest of the mechanism.. Attached to rack slides 74, 76, 78 and 80 are shaft-mounting blocks 34, 36, 38 and 40, and shafts 22 and 24 with carry opposing sets of fingertips 20. Blocks 34, 36, 38 and 40 act as floating connectors between shafts 22 and 24 and rack slides 74, 76, 78 and 80, respectively, permitting the shafts to move up and down relative to the cam. Both sets of fingertips 20 are aligned with and oriented towards mold cores 14 (see FIG. 1). By means of rollers 26, 28, 30 and 32 (see FIG. 1) attached to the ends of shafts 22 and 24, the shafts and fingers follow cam paths 66, 68, 70 and 72 on the x-z plane. Cam paths 66, 68, 70 and 72 are dimensioned and configured so that fingertips 20 travel along the x-z plane along a predetermined path between a first position as shown in FIG. 1 wherein the fingertips are clear of the mold cores and a second position wherein the finger bears against the lid portion of the plastic part on core portion 18 (shown on FIG. 1) to close the plastic part. Shaft-mounting blocks 34, 36, 38, and 40 together with stripper bolts 42, 44, 46 and 48 permit shafts 22 and 24 (together with fingertips 20) to follow the custom cam paths along the z-axis.

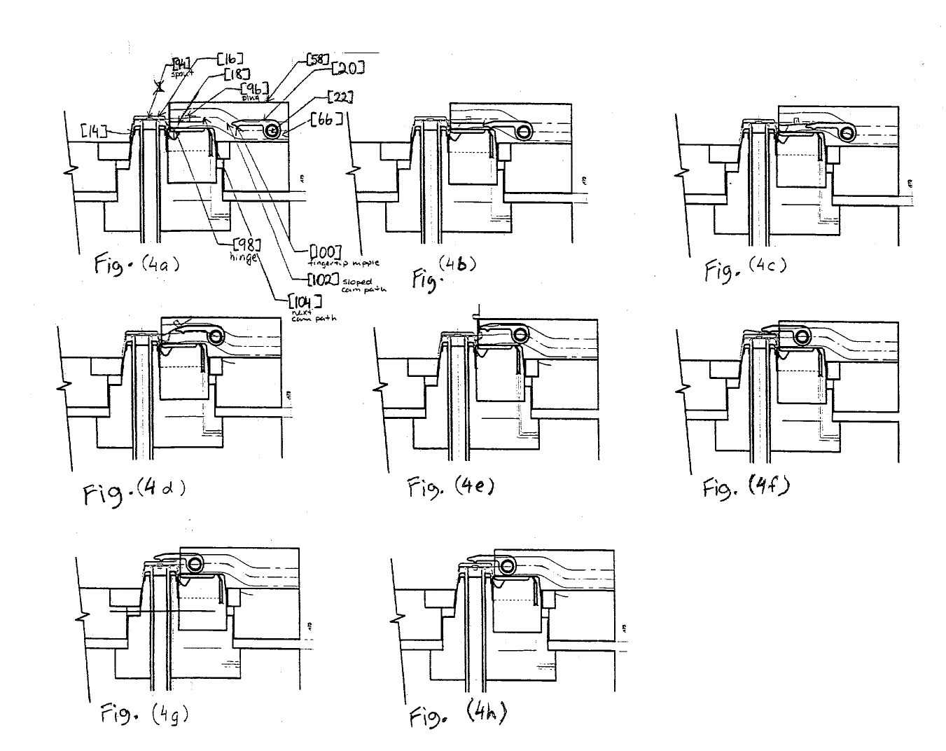

Referring now to FIGS. 4a through 4h, the operation of the in-mold closing mechanism will now be discussed in greater detail. FIGS. 4a through 4h illustrate a sequence of incremental movements of one isolated fingertip along the predetermined path on the x-z plane which is defined by the cam path. It will be appreciated that the required predetermined path is set by the type of part being molded. The cam path is customized to create the proper predetermined path which the fingertips are to follow in order to properly fold close the plastic part.

As shown on FIG. 4a, a molded part resides on mold core 14. In the present case, the molded part is a flip-top cap, which is also commonly referred to as a flip-top closure; however, any plastic part which is intended to be folded closed may be molded. The part is sub-divided into two components, namely a neck/capsule 16 portion and a lid portion 18. Lid portion 18 is dimensioned and configured to be folded over and onto neck/capsule 16 portion. Spout 94 is formed on the neck/capsule 16 and plug 96 is formed on the lid 18. Neck/capsule 16 and lid portion 18 are attached by means of hinge 98. Once the mold opens, the cooled molded part will reside on core 14. Fingertip 20 of shaft 22 is positioned at the outer most end of the cam path 66 along the x-axis and is oriented towards lid portion 18. This is the starting (or first) position of the fingertip's movement.

Immediately after the mold opens, the molded part is slightly pushed off the core in the positive z-direction (by means of the mold's part ejection mechanism) and the drive source assembly (see FIG. 1) is then activated to move shaft 22 along cam path 66 of cam 58 in a negative direction (i.e. towards mold core 14). As shown in FIG. 4b, when the shaft proceeds along cam path 66, fingertip 20 moves along the x-axis towards the mold core. Fingertip 20 contacts the outer most point of lid 18 when shaft 22 reaches the beginning of sloped portion 102 of cam path 66.

As seen in FIG. 4c, shaft 22 continues to travel along cam path 66 and up sloped portion 102 in the x-z plane (negative direction along x-axis and positive direction along z-axis). The point of contact between fingertip 20 and the plastic part moves under and closer to the center of lid 18. As the shaft continues in the negative direction (see FIG. 4d), shaft 22 begins to reach the end of the sloped portion 102 of cam path 66. Fingertip 20 continues to move in the x-z plane and starts to lift lid 18. When shaft 22 reaches the end of sloped portion 102, lid 18 is approximately 25% closed.

When shaft 22 continues along cam path 66 past sloped section 102 (see FIG. 4e) fingertip 20 is urged against lid 18. The lid 18 is now approximately 50% closed. Fingertip 20 with attached shaft 22 then travels more or less along the x-axis in the negative direction, along portion 104 of cam path 66 (see FIG. 4f). The fingertip 20 now travels to the top of the lid 18. The Lid is almost in its fully closed position as indicated by the contact of the spout 94 and the plug 96. Plug 96 is not yet sealed into spout 94.

When fingertip 20 with attached shaft 22 approaches the final portion of cam path 66 (see FIG. 4g), fingertip nipple 100 begins to slide on to the top surface of lid 18 above plug 96 and spout 94. Finally, as seen in FIG. 4h, fingertip 20 with attached shaft 22 reaches its final destination point and fingertip nipple 100 aligns with the center of the spout 94 and plug 96 and forces the plug to seal into the spout. The part is now fully folded. Before the part can be ejected, the drive source assembly is reversed to retract shaft 22 and fingertip 20 following reverse sequence from 4h through 4a.

The present described invention permits the in-mold lid closing of molded flip-top caps and similar molded parts. The closing mechanism performs the folding operation inside the mold between molding cycles and therefore eliminates the need for a separate folding operation outside the mold. The fingertips and cam paths can be custom designed to allow the fingertip to reach different positions on the lid to perform close lid function. The closed flip-top caps are ejected from the mold fully assembled and ready for either packaging or the next operation. The same in-mold lid closing mechanism can be applied to the flip-top closures or to any other plastic article which is intended to be folded after molding.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A mold core half for molding a plastic part and for folding said molded part while the part is still on the core half, said device comprising:
a mold core half having a mold core,
a finger,
the finger being movably mounted adjacent the mold core half and movable along a predetermined path between a first position wherein the finger is clear of the mold core and a second position wherein the finger bears against the part on the mold core so as to fold the part, and
a drive for driving the finger between its first and second positions.

2. The mold core half of claim 1 further comprising a cam mounted to the mold half and an elongated arm, the finger mounted to the elongated arm, the cam having a cam path which defines the predetermined path, the arm being coupled to the cam path.

3. The mold core half of claim 2 wherein the drive is coupled to the arm by a rack and pinion assembly.

4. The mold core half of claim 3 wherein the rack and pinion assembly comprises a rack slider coupled to the arm, a pinion gear coupled to the rack slider and a main rack coupled to the pinion gear, the drive being coupled to the main rack, the drive being able to move the rack back and forth.

5. The mold core half of claim 4 wherein the arm is mounted to the rack slider by a floating connector, the floating connector allowing the arm to move up and down relative to the rack slider.

6. The mold core half of claim 4 wherein the arm comprises an elongated bar having opposite ends, the finger being mounted between said opposite ends, at least one of said ends engaging the cam path of the cam.

7. The mold core half of claim 6 further comprising at least two sliders and at least two pinion gears, each slider slidably mounted to an opposite side of the mold core half and wherein each pinion gear engages both the main rack and one of the sliders, and wherein the bar is mounted to each slider by a separate floating connector, the floating connectors permitting the bar to move up and down relative to the slider.

8. The mold core half of claim 7 wherein the mount further comprises at least two cams, each cam having a cam path, the cams being mounted to the opposite sides of the mold core half, the ends of the bar engaging the cam paths of the cams.

9. The mold core half of claim 7 wherein the floating connectors each comprise a block mounted to the bar, each block being mounted to its respective slider by at least one stripper bolt.

10. A mold core half for molding a plastic part having a first and second portion, the first portion of the part being foldable onto the second portion of the part, said mold core half comprising:
a mold core half having at least one mold core,
at least one finger for physically folding the plastic part,
the finger being mounted to an elongated member which is slidably mounted to the mold core half, the finger movable along a predetermined between a first position wherein the finder is clear of the mold core and a second position wherein the finger bears against the first portion of the part to fold it onto the second portion of the part, and
a drive for driving the finger between its first and second positions.

11. The mold core half of claim 10 further comprising a cam mounted to the mold half, the cam having a cam path which defines the predetermined path, the arm being coupled to the cam path, and wherein the drive is coupled to the arm by a rack and pinion assembly.

12. The mold core half of claim 1 1 wherein the rack and pinion assembly comprises a rack slider coupled to the arm, a pinion gear coupled to the rack slider and a main rack coupled to the pinion gear, the drive being coupled to the main rack, the drive being able to move the rack back and forth.

13. The mold core half of claim 12 wherein the arm comprises an elongated bar having opposite ends, the finger being mounted between said opposite ends, and further comprising at least two rack sliders and at least two pinion gears, each rack slider slidably mounted to an opposite side of the mold core half and wherein each pinion gear engages both the main rack and one of the sliders, and wherein the bar is mounted to each slider by a separate floating connector, the floating connectors permitting the bar to move up and down relative to the slider.

14. The mold core half of claim 13 further comprising at least two cams, each cam having a cam path, the cams being mounted to the opposite sides of the mold core half, the ends of the bar engaging the cam paths of the cams.

15. The mold core half of claim 14 further comprising at least two cams, each cam having a cam path, the cams being mounted to the opposite sides of the mold core half, the ends of the bar engaging the cam paths of the cams and wherein the floating connectors each comprise a block mounted to the bar, each block being mounted to its respective slider by at least one stripper bolt.

16. The mold core half of claim 15 wherein the mold core half has a plurality of mold cores and at least one finger for each mold core.

17. The mold core half of claim 1 wherein the finger is movable across the mold core half parallel to a plane of the mold core half and wherein the finger is movable up and down relative to the core of the mold core half.

18. The mold core half of claim 10 wherein the mold core half further comprises a part ejector for ejecting parts off the mold core, the ejector capable of partially ejecting the part such that the part sits freely on the mold core half.

19. A method of in-mold folding of a foldable plastic part molded on a mold core in a mold core half of a plastic injection mold, said plastic part having a first and second portion, the first portion of the part being foldable onto the second portion of the part, the method comprising:
projecting a finger across a face of the mold core half and towards the plastic part sitting on the mold core such that the finger engages a lower edge of the first portion of the plastic part,
forcing the finger upwardly away from the mold core and towards the second portion of the plastic part to fold the first portion onto the second portion, and
moving the finger clear of the mold core after the plastic part has been folded.

20. The method of claim 19 further comprising the step of partially ejecting the plastic part after the part has been molded such that the part sits freely on top of the mold core and wherein the finger is moved across the face of the mold core half along a predetermined path, the predetermined path having a first portion wherein the finger moves in a forward direction towards the mold core parallel to the face of the mold core half, a second portion, wherein the finger continues to move in the forward direction and also in an upward direction away from the mold core, and a third portion wherein the finger continues to move in the first direction to force the first portion of the plastic part onto the second portion of the plastic part.
